(19) United States
(12) Patent Application Publication
(10) Pub. No.: US 2009/0179064 A1
(43) Pub. Date: Jul. 16, 2009

(54) System and method for restoring metal components

(75) Inventors: Glenn Hong Guan Lee, Singapore (SG); Wee Kwong Na, Singapore (SG); Kin Keong Jek, Singapore (SG); Garimella Balaji Rao, Singapore (SG)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Turbine Overhaul Service Pte Ltd, Jurong Town (SG)

(21) Appl. No.: 12/079,022

(22) Filed: Mar. 24, 2008

(30) Foreign Application Priority Data
Jan. 10, 2008 (SG) 200800233-9

(51) Int. Cl. B23K 1/002; B23K 31/02; B23K 35/24

(52) U.S. Cl. 228/41; 228/119; 228/262.9

(57) ABSTRACT

A system for restoring a metal component with a brazing alloy, the system comprising an induction coil configured to extend around a portion of the metal component and at least a portion of the brazing alloy, a motion assembly configured to cause relative movement between the metal component and the induction coil along a first axis, and a heat exchanger assembly supported by the motion assembly and configured to form a thermal gradient along the metal component in a direction along the first axis.

### CROSS-REFERENCE TO RELATED APPLICATION(S)

This application claims priority of Singapore Patent Application No. 200800233-9, filed on Jan. 10, 2008, and entitled “SYSTEM AND METHOD FOR RESTORING METAL COMPONENTS”, the disclosure of which is incorporated by reference in its entirety.

### BACKGROUND

The present invention relates to systems and methods for restoring metal components. In particular, the present invention relates to systems and methods for restoring metal components derived from single crystal alloys, such as gas turbine engine components.

Single crystal alloys are typically employed in gas turbine engine components due to the high mechanical strengths and creep resistances obtained with such alloys. Because gas turbine engine components are exposed to extreme temperatures and pressures, high mechanical strengths and creep resistances are required to preserve the integrity of the engine over the course of operation. However, over time, exposed portions of the components are subject to wear and other degradations, which can lead to decreases in operational efficiencies.

Due to economic factors, it is common practice in the aerospace industry to restore turbine engine components rather than replace them. Such restorations desirably restore damaged regions of the engine components to their original dimensions. Turbine engine components are typically restored with brazing operations, which subject the single crystal alloys of the engine components to high temperatures (e.g., 1200° C./2200° F.) for extended durations (e.g., 10 hours). Exposure to the high temperatures for the extended durations, however, reduces the low-temperature creep resistances of the single crystal alloys. Additionally, the restored portions of engine components restored with standard brazing operations typically have polycrystalline microstructures, which have lower mechanical strengths and creep resistances compared to the microstructures of single crystal alloys. Accordingly, there is a need for systems and techniques for restoring metal components (e.g., turbine engine components) that are capable of creating restored portions with directionally-solidified microstructures.

### SUMMARY

The present invention relates to a system and method for restoring a metal component. The system includes an induction coil configured to extend around a portion of the metal component and at least a portion of the brazing alloy, a motion assembly configured to cause relative movement between the metal component and the induction coil along a first axis, and a heat exchanger assembly supported by the motion assembly and configured to form a thermal gradient along the metal component in a direction along the first axis.

### BRIEF DESCRIPTION OF THE DRAWINGS

FIG. 1 is a front perspective view of an induction heating system for restoring metal components.

FIG. 2 is an exploded side view of the induction heating system.

FIG. 3 is a side view of the induction heating system disposed in an elevated position.

FIG. 4 is a side view of the induction heating system disposed in a lowered position.

FIG. 5 is a sectional view of a heat exchanger assembly of the induction heating system in use with a radiation insulator containing a turbine blade.

FIG. 6 is a side view of an alternative induction heating system disposed in a lowered position.

### DETAILED DESCRIPTION

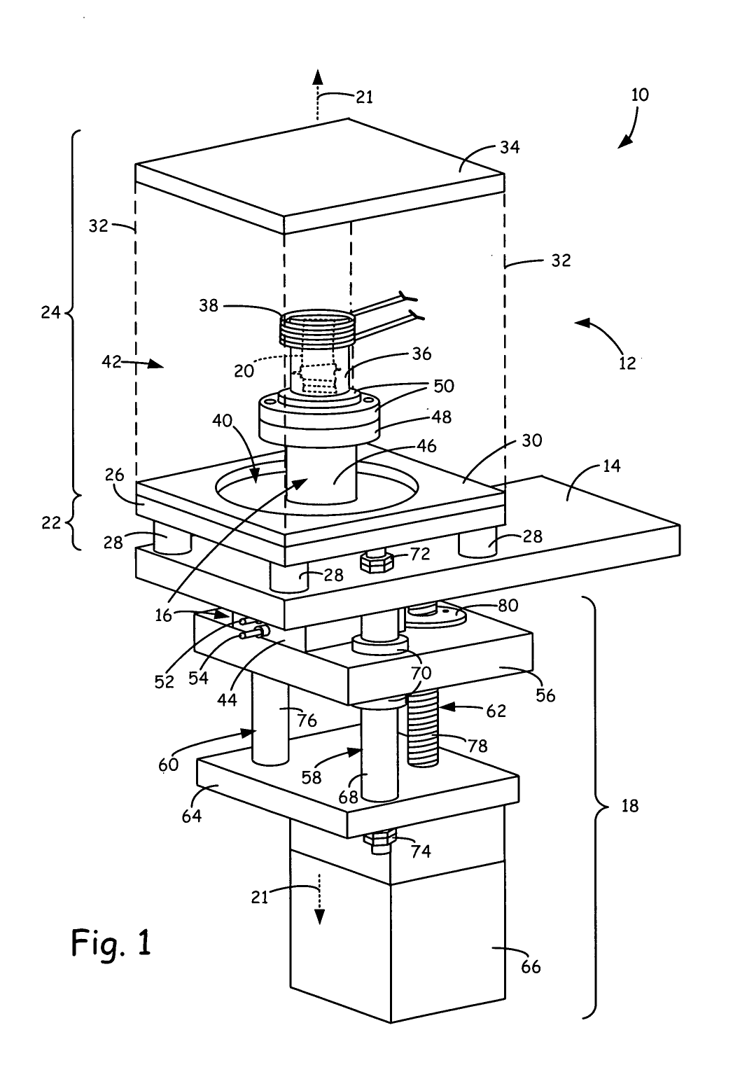

FIG. 1 is a front perspective view of system 10, which is an induction heating system for restoring metal components (e.g., turbine engine blades and vanes) with an induction brazing process. As shown, system 10 includes induction chamber 12, support plate 14, heat exchanger assembly 16, and motion assembly 18, where induction chamber 12 contains a damaged turbine blade that requires restoration (referred to as blade 20, and shown with hidden lines). As discussed below, system 10 is configured to create a near-linear thermal gradient along a longitudinal axis of blade 20 (referred to as longitudinal axis 21) and to move blade 20 at a suitable rate along longitudinal axis 21. This increases the ability to obtain a directionally-solidified microstructure for the restored tip of blade 20, where the directionally-solidified microstructure obtained is desirably similar to a single crystal microstructure. As used herein, the term “along” with reference to an axis (e.g., longitudinal axis 21) refers to an orientation that is substantially coaxial with, or substantially parallel to, the axis. For example, moving blade 20 along longitudinal axis 21 refers to the movement of blade 20 in a direction that is substantially coaxial with, or substantially parallel to, longitudinal axis 21.

Induction chamber 12 is an enclosable chamber that includes base portion 22 and cover portion 24. Base portion 22 of induction chamber 12 includes bottom platform 26 and chamber insulators 28, where bottom platform 26 is a platform that functions as a floor of induction chamber 12, and is removably securable to cover portion 24. This allows induction chamber 12 to be opened for access within cover portion 24 (by removing cover portion 24 from bottom platform 26), and closed (by securing cover portion 24 to bottom platform 26).

Chamber insulators 28 are standoff extensions secured between support plate 14 and bottom platform 26 that reduce the amount of conductive heat that transfers from induction chamber 12 to support plate 14. Support plate 14 retains moving components (e.g., motion assembly 18), which may be negatively affected by transferred conductive heat. Thus, chamber insulators 28 reduce the risk of subjecting such components to the heat produced by induction chamber 12. Examples of suitable materials for chamber insulators include polymeric materials having low thermal conductivities, such as fluoropolymers commercially available under the trademark “TEFLON” from E.I. du Pont de Nemours and Company, Wilmington, Del.

Cover portion 24 of induction chamber 12 includes chamber floor 30, chamber wall 32, chamber ceiling 34, radiation insulator 36, and induction coil 38. Chamber floor 30 and chamber ceiling 34 are the floor and ceiling components of cover portion 24, respectively. Chamber floor 30 is also the part of cover portion 24 that is removably securable to bottom platform 26 for opening and closing induction chamber 12. As shown, chamber floor 30 includes opening 40, which is a hole through chamber floor 30 that allows heat exchanger assembly 16 and radiation insulator 36 to be inserted within cover portion 24 prior to the induction heating process.

Chamber wall 32 is a lateral wall of cover portion 24, and is shown with broken lines in FIG. 1 for ease of discussion of the components located within induction chamber 12. Chamber wall 32 is desirably derived from one or more materials that provide structural support and restrict the emission of thermal radiation from induction chamber 12 (e.g., stainless steel). Chamber wall 32 defines interior region 42, which is the interior volume of cover portion 24, and extends from chamber floor 30 to chamber ceiling 34. In alternative embodiments, cover portion 24 may include additional walls and/or radiation shields to further reduce the emission of thermal radiation from induction chamber 12. For example, cover portion 24 may include an annular wall that is aligned with the perimeter of opening 40, thereby reducing the volume of interior region 42.

When chamber floor 30 is secured to bottom platform 26, interior region 42 of induction chamber 12 is desirably sealed off from the external environment, thereby allowing interior region 42 to contain one or more inert gases (e.g., argon), or to exhibit a reduced-pressure atmosphere or vacuum. Maintaining interior region 42 under a vacuum is particularly desirable because the vacuum reduces convective heat transfers within interior region 42. Convective heat transfer may increase the amount of lateral heating that blade 20 is subjected to, which can result in dislocation densities in the directionally-solidified microstructure. Thus, a reduction in the convective heat transfer is beneficial to obtain a near-linear thermal gradient along blade 20, which promotes directional solidification of a brazing alloy (not shown in FIG. 1). Examples of suitable vacuum pressures for performing the induction brazing process include about 13 millipascals (about 10⁻⁴ Torr) or less, with more particularly suitable pressures including about 1.3 millipascals (about 10⁻⁵ Torr) or less.

Radiation insulator 36 is a cylindrical component that encases blade 20 during the induction brazing process, and functions as a radiation shield for blade 20. Radiation heat transfer may occur whenever there is a temperature variation (e.g., between blade 20 and interior region 42), regardless of whether interior region 42 is maintained under a vacuum. As such, radiation insulator 36 reduces the amount of radiation-based heat that emits from blade 20 during an induction brazing process, which also promotes directional solidification of the brazing alloy. Suitable materials for radiation insulator 36 include materials having low electrical conductivities and that desirably reduce the emission of thermal radiation from a metal component during an induction brazing process. Examples of suitable materials for radiation insulator 36 include graphite-based materials (e.g., porous graphite). In the embodiment shown in FIG. 1, radiation insulator 36 also functions as a mold block for the brazing alloy, which shapes the restored tip of blade 20 during the induction brazing process. Alternatively, system 10 may also include a separate mold block insert (not shown) that is positionable within radiation insulator 36 for shaping the restored tip of blade 20.

Induction coil 38 is an electrically-conductive tubing that is disposed within interior region 42, and extends through chamber wall 32 for connection to an electrical current source (not shown) disposed outside of induction chamber 12. As discussed below, induction coil 38 provides localized heating to blade 20 and the brazing alloy disposed within radiation insulator 36. This allows the damaged portion of the blade 20 to be repaired via induction heating. As shown, induction coil 38 extends around a portion of radiation insulator 36 in a helical geometry. This arrangement desirably minimizes the distance between radiation insulator 36 and induction coil 38, while also allowing blade 20 and radiation insulator 36 to move along longitudinal axis 21. Induction coil 38 is desirably formed from one or more metallic materials that are electrically and thermally conductive (e.g., copper). Suitable tubing diameters for induction coil 38 include diameters ranging from about 3 millimeters to about 5 millimeters.

Support plate 14 is a rigid plate securable to a structural mount (e.g., a work bench, not shown) for supporting system 10 in a cantilevered manner. In alternative embodiments, support plate 14 may be replaced with different types of horizontal support structures configured to retain and support system 10.

Heat exchanger assembly 16 is a cooling assembly configured to maintain a thermal gradient along the longitudinal length of blade 20 (i.e., along longitudinal axis 21) during the induction brazing process. This promotes the directional solidification of the brazing alloy, which correspondingly increases the ability to obtain a directionally-solidified microstructure. Heat exchanger assembly 16 includes coupling manifold 44, coolant tube 46, chill block holder 48, and chill block 50, where coupling manifold 44 is disposed below support plate 14 and is secured to coolant tube 46. Coupling manifold 44 includes inlet port 52 and outlet port 54, which are fluid conduits configured to couple with inlet and outlet coolant water lines of an external refrigeration system (not shown). Coolant tube 46 is a fluid conduit that extends through bottom platform 26 and opening 40, and interconnects coupling manifold 44 and chill block holder 48. As discussed below, coolant tube 46 includes multiple annular channels (not shown in FIG. 1) that allow the coolant fluid to flow between coupling manifold 44 and chill block holder 48.

Chill block holder 48 is a first thermally-conductive component secured to the opposing end of coolant tube 46 from coupling manifold 44, and provides a mounting surface for securing chill block 50. Chill block 50 is a second thermally-conductive component removably secured to chill block holder 48, and is configured to receive and retain radiation insulator 36. Because chill block 50 is removably securable to chill block holder 48, multiple insulator mounts 52 may be interchangeably secured to chill block holder 48, thereby allowing metal components (e.g., blade 20) and radiation insulators 36 with a variety of different designs to be secured within induction chamber 12. This allows system 10 to be used to restore a variety of different metal components.

When radiation insulator 36 is mounted on chill block 50, the base of blade 20 is desirably in thermally-conductive contact with chill block 50 to conductively transfer heat from blade 20 during the induction brazing process. This creates the thermal gradient along blade 20, which promotes the directional solidification of the brazing alloy along longitudinal axis 21. Accordingly, chill block holder 48 and chill block 50 are desirably formed from one or more thermally-conductive materials to increase the heat transfer between blade 20 and chill block 50. Suitable materials for chill block holder 48 and chill block 50 include thermally-conductive metallic materials (e.g., copper), and chill block 50 may also be coated with one or more materials (e.g., plated nickel) to prevent contamination between the thermally-conductive material of chill block 50 and the base alloy of blade 20. The thermal gradient extends along longitudinal axis 21 because of the relative locations of induction coil 38 and chill block 50. As shown, the source of heat (i.e., induction coil 38) and the source of cooling (i.e., chill block 50) are offset from each other along longitudinal axis 21. Accordingly, heat transfer mechanics causes the thermal gradient in blade 20 to form along longitudinal axis 21.

Motion assembly 18 is a threaded-screw drive mechanism configured to move blade 20 and radiation insulator 36 along longitudinal axis 21 relative to induction coil 38. Motion assembly 18 includes slide plate 56, linear bearing assemblies 58 and 60, threaded shaft assembly 62, end plate 64, and motor 66. As shown, the arrangement of motion assembly 18 positions motor 66 at an offset location relative to longitudinal axis 21. This reduces any potential interferences of magnetic flux between induction coil 38 and motor 66, and also prevents coolant fluid from inlet port 52 and outlet port 54 of coupling manifold 44 from accidentally dripping on to motor 66.

Slide plate 56 is a first plate for supporting coupling manifold 44. As discussed below, slide plate 56 is retained by linear bearing assemblies 58 and 60, and is engaged with threaded shaft assembly 62 for movement along longitudinal axis 21. Linear bearing assemblies 58 and 60 are linear guides that restrict the movement of slide plate 56 to upward and downward directions along longitudinal axis 21. Linear bearing assembly 58 includes pillar shaft 68 and linear bushing 70, where pillar shaft 68 has a first end secured to support plate 14 with retention nuts 72, and a second end secured to end plate 64 with retention nuts 74. Linear bushing 70 extends through slide plate 56, and provides a shaft for pillar shaft 68 to slide through. Linear bearing assembly 60 includes pillar shaft 76, which has a first end secured to support plate 14 (with retention nuts, not shown), and a second end secured to end plate 64 (with retention nuts, not shown). Linear bearing assembly 60 also includes a linear bushing (not shown) that functions in the same manner as linear bushing 70. Thus, linear bearing assemblies 58 and 60 restrict the movement of slide plate 56 to directions along longitudinal axis 21.

Threaded shaft assembly 62 includes threaded screw 78 and screw nut 80, where threaded screw 78 has a first end secured to support plate 14 and a second end that extends through end plate 64 and engages with motor 66. Screw nut 80 extends through slide plate 56 and is threadedly engaged with threaded screw 78, thereby allowing the rotation of threaded screw 78 to move slide plate 56 upward and downward along longitudinal axis 21. End plate 64 is a second plate supported by pillar shafts 68 and 76, and provides a support surface for mounting motor 66. Motor 66 is an electrical motor (e.g., a stepper motor) configured to apply rotational power to threaded screw 78 during the induction brazing process to move blade 20 downward along longitudinal axis 21 relative to induction coil 38. As discussed below, the downward motion of blade 20 allows successive portions of the brazing alloy to melt via induction heating, thereby forming the restored tip of blade 20.

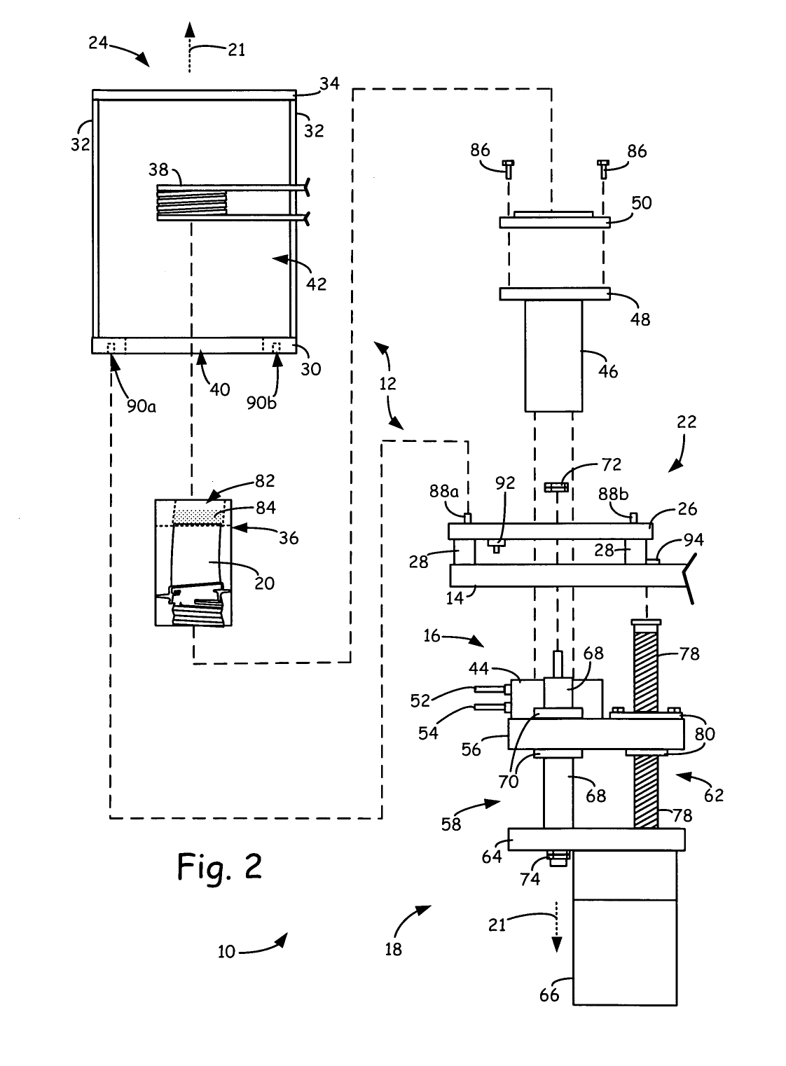

FIG. 2 is an exploded side view of system 10, further illustrating the components of system 10. As shown, radiation insulator 36 includes mold cavity 82, which is a cavity that conforms to the desired dimensions of the restored tip of blade 20. Prior to performing the induction brazing process, blade 20 is inserted within radiation insulator 36, and mold cavity 82 is at least partially filled with brazing alloy 84. Brazing alloy 84 is desirably provided as a powder having nanosize and/or microsize particles. Examples of suitable materials for brazing alloy 84 include alloys containing nickel and/or cobalt, and may also include one or more additional metals such as titanium, chromium, niobium, hafnium, tantalum, molybdenum, tungsten, aluminum, and iron. Particularly suitable alloys for the nanoparticle alloy include nickel-based alloys, nickel-based superalloys, cobalt-based alloys, cobalt-based superalloys, and combinations thereof. The composition of brazing alloy 84 desirably maintains a nickel concentration within the limit of the base alloy of blade 20. Examples of suitable materials for blade 20 include single crystal alloys based on nickel, cobalt, and combinations thereof (e.g., PWA 1480 and PWA 1484 alloys).

As further shown, chill block 50 is removably securable to chill block holder 48 with screws 86, thereby allowing chill block 50 to be interchanged with chill blocks having different designs. When chill block 50 is secured to chill block holder 48 with screws 86, radiation insulator 36 (containing blade 20 and brazing alloy 84) may then be mounted on chill block 50 such that blade 20 is in thermally-conductive contact with chill block 50. Cover portion 24 of induction chamber 12 may then be secured to bottom platform 26 with the use of alignment pins 88a and 88b, and alignment slots 90a and 90b. Alignment pins 88a and 88b are pins extending upward from bottom platform 26, and alignment slots 90a and 90b are slots within chamber floor 30 that line up with alignment pins 88a and 88b, respectively. This allows cover portion 24 to be secured to bottom platform 26 during the induction brazing process.

As discussed above, when chamber floor 30 is secured to bottom platform 26, interior region 42 of induction chamber 12 is desirably sealed off from the external environment, thereby allowing interior region 42 to contain one or more inert gases, or to exhibit a reduced-pressure atmosphere or vacuum. As such, system 10 also includes gas port 92, which extends through bottom platform 26 to allow access to interior region 42. In the embodiments in which interior region 42 is filled with an inert gas, gas port 92 may be coupled to a pressurized gas source (not shown) to allow the inert gas to fill interior region 42. Alternatively, in the embodiments in which interior region 42 exhibits a reduced-pressure atmosphere or vacuum, gas port 92 may be coupled to a pump assembly (not shown) to remove a portion or all of the gases within interior region 42.

As further shown in FIG. 2, threaded shaft assembly 62 also includes retention nut 94, which is located above support plate 14, and aligned with threaded screw 78. During the assembly of system 10, the first end of threaded screw 78 is inserted through support plate 14, and is secured to support plate 14 with retention nut 94. This allows threaded shaft assembly 62 to move slide plate 56 along longitudinal axis 21.

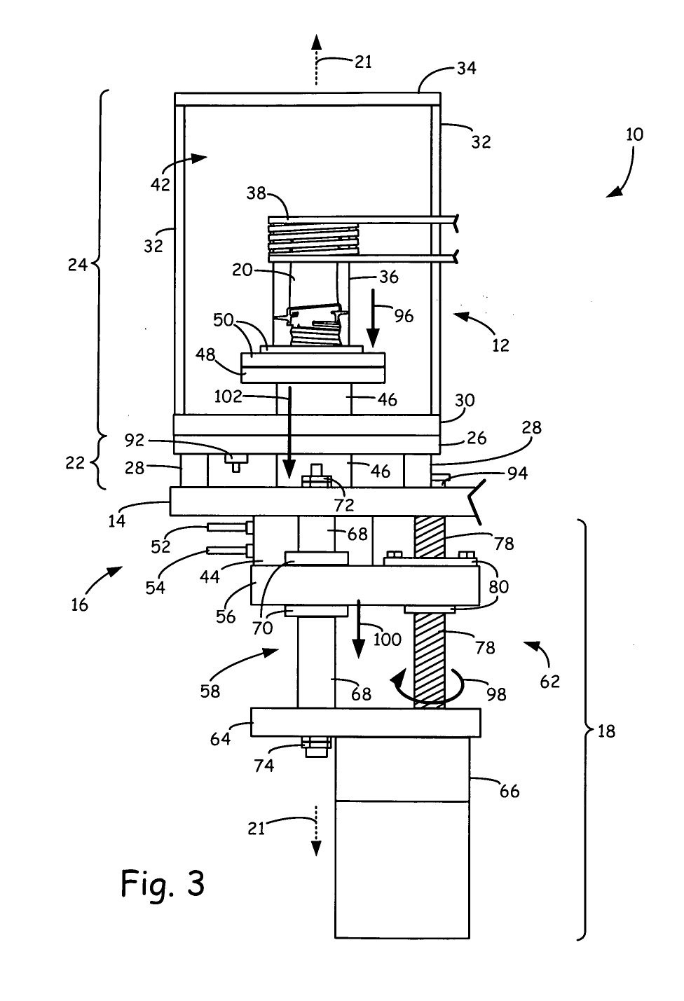

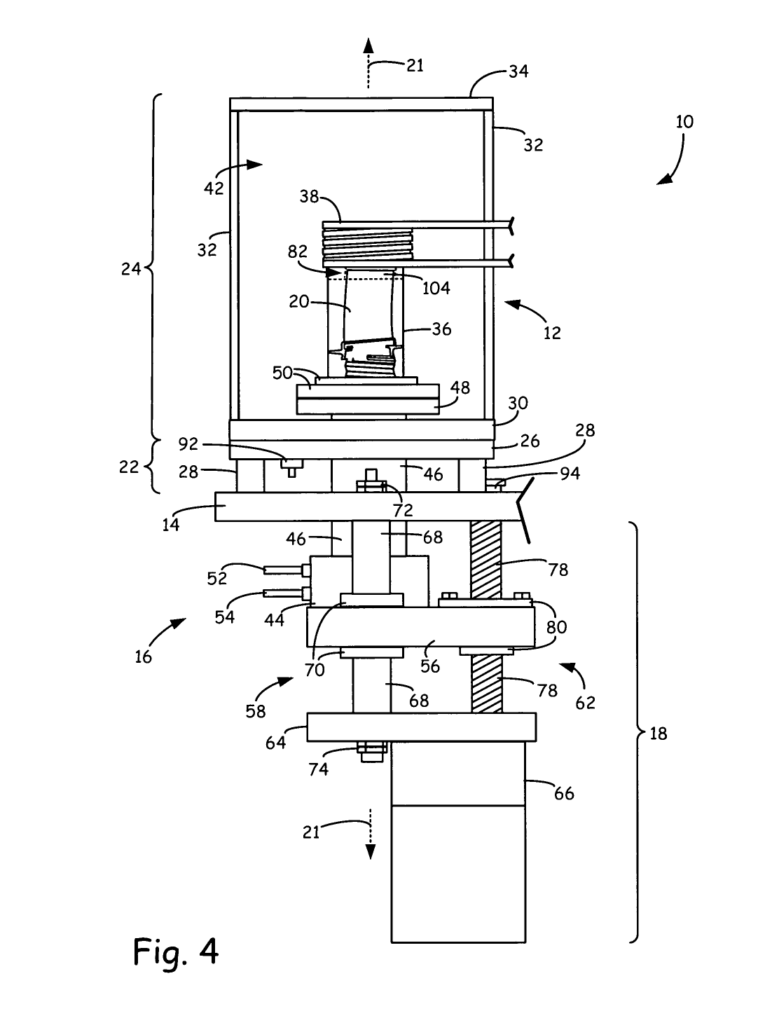

FIGS. 3 and 4 are side views of system 10 during an induction brazing process. As shown in FIG. 3, system 10 is disposed in an elevated position such that a portion of blade 20 and a portion of radiation insulator 36 extend within induction coil 38. Prior to the induction brazing process, blade 20 is inserted within radiation insulator 36, and brazing alloy 84 (shown in FIG. 2) is deposited in mold cavity 82 of radiation insulator 36 (shown in FIG. 2). Radiation insulator 36 is then mounted on chill block 50 such that the base of blade 20 contacts chill block 50. Interior region 42 of induction chamber 12 is then desirably purged of gases to create a vacuum condition (or, alternatively, filled with one or more inert gases) via gas line 92. Coolant fluid is then introduced to heat exchanger assembly 16 via inlet port 52, thereby cooling chill block 50. This correspondingly cools blade 20 due to the conductive contact between blade 20 and chill block 50.

An electrical current is then introduced to induction coil 38, thereby heating the tip of blade 20 and brazing alloy 84. The electrical current applied to induction coil 38 creates a magnetic field in the region within the helical geometry of induction coils 38. Because the tip of blade 20 and a portion of the brazing alloy are located within this region, the magnetic field induces eddy currents within the tip of blade 20 and the brazing alloy, thereby generating localized heat in a non-contact manner. The induction heating of the tip of blade 20 and the cooling of the base of blade 20 (via chill block 50) forms a thermal gradient along blade 20 in the direction of longitudinal axis 21. As discussed above, the vacuum condition of interior region 42 reduces the amount of convective heat transfers, and radiation insulator 36 reduces the amount of thermal radiation emitted from blade 20. As such, the thermal gradient is a near-linear thermal gradient, which increases the ability to obtain a directionally-solidified microstructure. While the near-linear thermal gradient is maintained, the induction heating melts the portion of brazing alloy 84 located at the localized region within the helical geometry of induction coil 38. This allows the brazing alloy 84 to fuse with the tip of blade 20 with reduced dislocation densities in the resulting crystal microstructure, thereby promoting directional solidification of the fused brazing alloy 84.

Suitable brazing temperatures for the induction brazing process may vary depending on the alloys used for blade 20 and brazing alloy 84. Examples of suitable brazing temperatures for the induction brazing process range from about 1100° C. to about 1400° C., with particularly suitable brazing temperatures ranging from about 1200° C. to about 1300° C., where the brazing temperature is the temperature of the tip of blade 20 and brazing alloy 84 at the localized heating region within induction coil 38. As discussed below, the brazing temperature may be indirectly measured by the thermal effects on the coolant fluid flowing through heat exchanger assembly 16.

To further promote directional solidification of brazing alloy 84, motion assembly 18 moves blade 20 and radiation insulator 36 downward along longitudinal axis 21 (represented by arrow 96) at a rate that substantially corresponds to the growth rate of the fused brazing alloy 84. Suitable movement rates may vary depending on several factors, such as the compositions of brazing alloy 84 and the base alloy of blade 20, the volume of the restored tip of blade 20, and the characteristics of the thermal gradient along blade 20. Examples of suitable movement rates along longitudinal axis 21 range from about 0.01 millimeters/minute to about 50 millimeters/minute, with particularly suitable movement rates ranging from about 10 millimeters/minute to about 30 millimeters/minute.

As discussed above, motion assembly 18 moves blade 20 and radiation insulator 36 downward along longitudinal axis 21 with motor 66. Motor 66 applies rotational power to threaded screw 78, which causes threaded screw 78 to rotate in a first rotational direction (represented by arrow 98). The threaded engagement between threaded screw 78 and screw nut 80 causes slide plate 56 to move downward, where linear bearing assembly 58 and linear bearing assembly 60 (shown in FIG. 1) restrict the downward movement of slide plate 56 to a linear direction along longitudinal axis 21 (represented by arrow 100). In an alternative embodiment, threaded screw 78 and screw nut 80 are configured to move slide plate 56 downward when threaded screw 78 is rotated in an opposite rotational direction from the rotation direction of arrow 98. The downward movement of slide plate 56 correspondingly moves heat exchanger assembly 16 (i.e., coupling manifold 44, coolant tube 46, chill block holder 48, and chill block 50) downward in the same direction (represented by arrow 102). This correspondingly moves blade 20 and insulator mount 36 downward along longitudinal axis 21 in the direction of arrow 96.

The downward movement of blade 20 and insulator mount 36 causes successive portions of brazing alloy 84 to lower into the localized heating region of induction coil 38. This melts the successive portions of brazing alloy 84, thereby allowing the melted successive portions to conform to the dimensions of mold cavity 82 (shown in FIG. 2). As the melted portions move below the localized heating region of induction coil 38, the near-linear thermal gradient along blade 20 correspondingly causes the melted successive portions to fuse to the tip of blade 20 and directionally solidify along longitudinal axis 21.

FIG. 4 shows system 10 after the induction brazing process is complete, where system 10 is disposed in a lowered position such that blade 20 is disposed below induction coil 38. As shown, after the induction brazing process, blade 20 includes restored tip 104, which is formed from the directionally-solidified brazing alloy 84 (shown in FIG. 2). Accordingly, restored tip 104 desirably exhibits a directionally-solidified microstructure, which is desirably similar to a single crystal -microstructure, and substantially preserves the high mechanical strengths and creep resistances of the base alloy of blade 20. After the induction brazing process is complete, cover portion 24 may be removed from bottom platform 26, and restored blade 20 may be removed. Restored blade 20 may then undergo post-brazing operations, such as machining and smoothing processes, to obtain the original dimensions of blade 20.

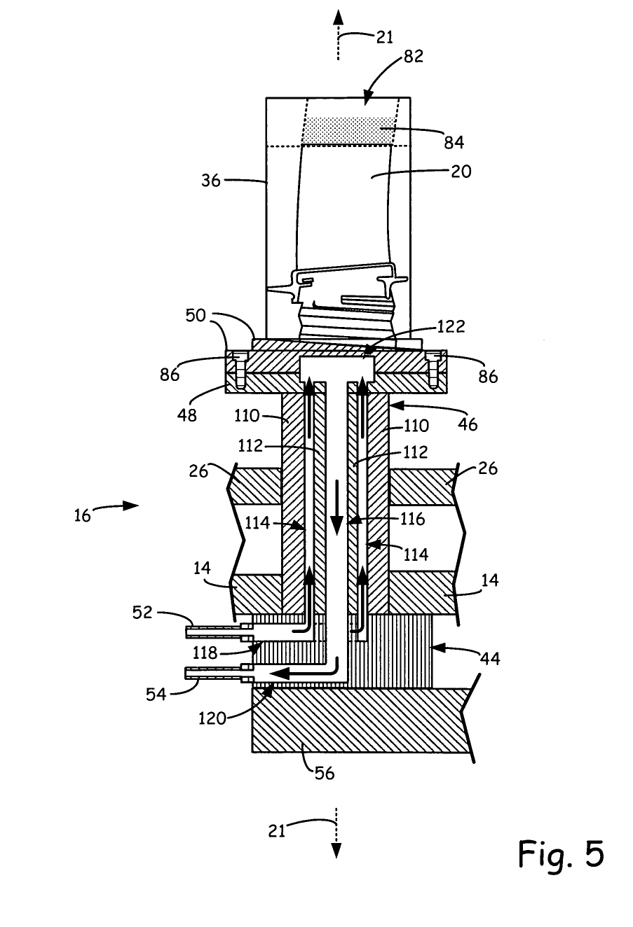

FIG. 5 is an expanded view of heat exchanger assembly 16 in use with blade 20 and radiation insulator 36, where heat exchanger assembly 16 is shown in section. As shown, coolant tube 46 includes exterior wall 110 and interior wall 112, each of which are annular walls that define outer channel 114 and inner channel 116. Outer channel 114 and inner channel 116 are coaxial fluid conduits for the coolant fluid to flow through. Exterior wall 110 and interior wall 112 are desirably formed from thermally-insulative materials or include thermally-insulative coatings to reduce thermal transfers from outer channel 114 and inner channel 116. Examples of suitable materials for exterior wall 110 and interior wall 112 include polymeric materials having low thermal conductivities, such as fluoropolymers commercially available under the trademark “TEFLON” from E.I. du Pont de Nemours and Company, Wilmington, Del. Bottom platform 26 also desirably includes a seal mechanism (not shown) with outer wall 110 that allows interior region 42 to remain sealed off from the external environment, while also allowing coolant tube 46 to move upward and downward along longitudinal axis 21.

Coupling manifold 44 also includes inlet pathway 118 and outlet pathway 120, where inlet pathway 118 interconnects inlet port 52 and outer channel 114, and outlet pathway 120 interconnects outlet port 54 and inner channel 116. On the top end of coolant tube 46, chill block holder 48 and chill block 50 define cavity 122 when secured together with screws 86. As shown, cavity 122 connects with outer channel 114 and inner channel 116 at the opposing ends from coupling manifold 44. This arrangement of heat exchanger assembly 16 allows the coolant fluid to flow from inlet port 52, through inlet pathway 118 and outer channel 114, to cavity 122. The coolant fluid in cavity 122 draws heat from chill block 50, which correspondingly forms the thermal gradient along blade 20 due to the conductive contact between blade 20 and chill block 50. As discussed above, the thermal gradient increases the ability to obtain a directionally-solidified microstructure from brazing alloy 84, and also substantially preserves the mechanical properties of the base alloy of blade 20.

After entering cavity 122 and drawing a portion of the heat from chill block 50, the coolant fluid then flows down through inner channel 116 and outlet pathway 120; and exits coupling manifold 44 via outlet port 54. The outgoing coolant fluid desirably flows to an external refrigeration system (not shown) that is connected to inlet port 52 and outlet port 54 for providing a coolant loop. If desired, the power requirements of the external refrigeration system may be monitored to determine the brazing temperature of blade 20 and brazing alloy 84 during the induction brazing process. In this embodiment, the thermal profile along blade 20 is measured prior to performing the induction brazing process to determine the heat transfer coefficient between the tip of blade 20 and cavity 122. Based on the predetermined heat transfer coefficient, and the power requirements of the external refrigeration system for continuously cooling the coolant fluid, the brazing temperature may be continuously monitored during the induction brazing process. This allows the electrical current applied to induction coil 38 (shown in FIGS. 1-4) to be adjusted (manually or in an automated manner with a process control loop) to maintain a desired brazing temperature.

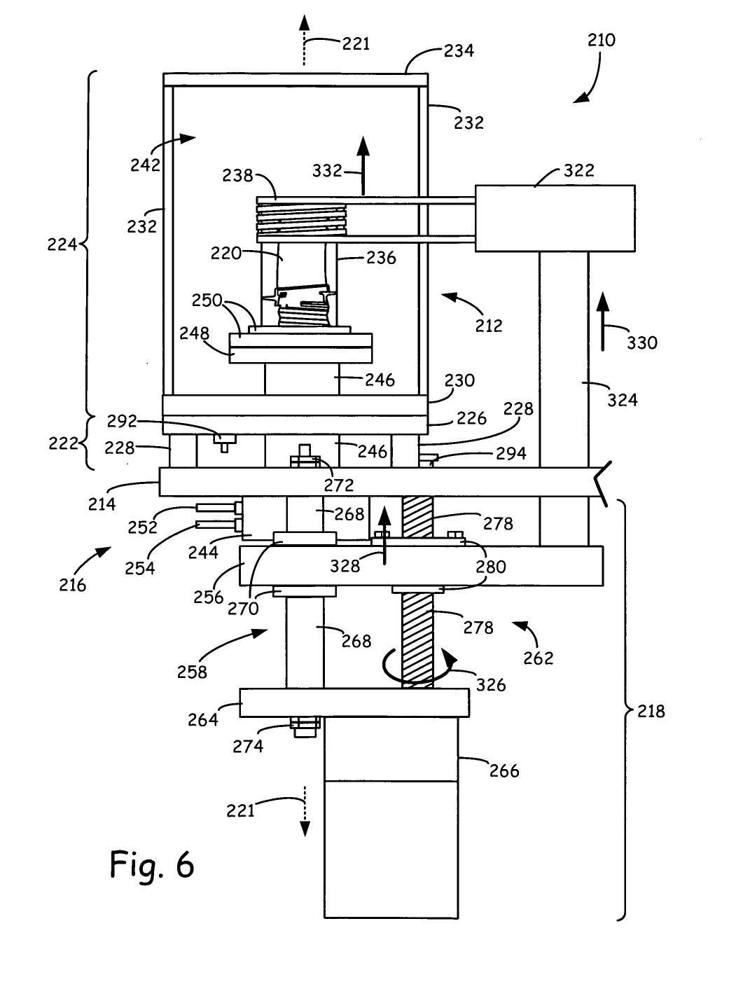

FIG. 6 is a side view of system 210, which is an alternative embodiment to system 10 (shown in FIGS. 1-5), where reference labels of corresponding components are increased by “200”. As shown in FIG. 6, motor assembly 218 is configured to move induction coil 238 upward along longitudinal axis 221 relative to metal component 220 and radiation insulator 236. In this embodiment, coupling manifold 244 is secured to the bottom of support plate 214 such that heat exchanger assembly 216 is not supported by slide plate 256. Thus, heat exchanger assembly 216, metal component 220, and radiation insulator 236 desirably do not move in this embodiment.

As further shown, system 210 includes power source 322 and support shaft 324, where power source 322 is connected to induction coil 238 for providing an electrical current to induction coil 328. Support shaft 324 is a shaft that interconnects slide plate 256 and power source 322, thereby allowing motion assembly 218 to move induction coil 228 and power source 322 along longitudinal axis 221 in a similar manner to motion assembly 18 (shown in FIGS. 1-4). Accordingly, during an induction brazing operation, motion assembly 218 moves induction coil 228 and power source 322 upward along longitudinal axis 221 with motor 266.

Motor 266 applies rotational power to threaded screw 278, which causes threaded screw 278 to rotate in a first rotational direction (represented by arrow 326). The threaded engagement between threaded screw 278 and screw nut 280 causes slide plate 256 to move upward, where linear bearing assembly 258 and linear bearing assembly 260 (not shown) restrict the upward movement of slide plate 256 to a linear direction along longitudinal axis 221 (represented by arrow 328). In an alternative embodiment, threaded screw 278 and screw nut 280 are configured to move slide plate 256 upward when threaded screw 278 is rotated in an opposite rotational direction from the rotation direction of arrow 326. The upward movement of slide plate 256 correspondingly moves support shaft 324 and power source 322 upward in the same direction (represent by arrow 330). This correspondingly moves induction coil 238 upward along longitudinal axis 21 (represented by arrow 332). Chamber wall 232 desirably provides a seal mechanism that allows interior region 242 to remain sealed off from the external environment, while also allowing induction coil 238 to move upward and downward along longitudinal axis 221. For example, chamber wall 232 may include one or more accordion baffle portions (not shown) that expand and contract with the movement of induction coil 238.

The upward movement of induction coil 238 causes the localized heating region of induction coil 238 to move upward into successive portions of brazing alloy 284 (not shown). This melts the successive portions of brazing alloy 284, thereby allowing the melted successive portions to conform to the dimensions of mold cavity 282 (not shown). As the melted portions fall below the localized heating region of induction coil 238, the near-linear thermal gradient along blade 220 correspondingly causes the melted successive portions to fuse to the tip of blade 220 and directionally solidify along longitudinal axis 221 in the same manner as discussed above for blade 20. Accordingly, the motion assemblies (e.g., motion assemblies 18 and 218) are configured to cause relative movements between the metal component (e.g., blades 20 and 220) and the induction coils (e.g., induction coils 38 and 238). In the embodiment shown in FIGS. 1-4, motion assembly 18 moves blade 20 downward along longitudinal axis 21 relative to induction coil 38, and in the embodiment shown in FIG. 6, motion assembly 218 moves induction coil 238 upward longitudinal axis 221 relative to blade 220.

Although the present invention has been described with reference to preferred embodiments, workers skilled in the art will recognize that changes may be made in form and detail without departing from the spirit and scope of the invention.

1. A system for restoring a metal component with a brazing alloy, the system comprising:
a chamber having an interior region;
an induction coil at least partially disposed within the interior region and configured to extend around a portion of a metal component and at least a portion of a brazing alloy disposed on the metal component;
a motion assembly configured to cause relative movement between the metal component and the induction coil along a first axis; and
a heat exchanger assembly configured to form a thermal gradient along the metal component in a direction along the first axis.

2. The system of claim 1, wherein the interior region is configured to maintain a vacuum.

3. The system of claim 1, further comprising a radiation insulator configured to reduce thermal radiation emitted from the metal component.

4. The system of claim 1, wherein the motion assembly is configured to move the metal component along the first axis relative to the induction coil.

5. The system of claim 1, wherein the motion assembly is configured to move the induction coil along the first axis relative to the metal component.

6. The system of claim 1, wherein the heat exchanger assembly comprises:
a coupling manifold configured to receive and output a coolant fluid; and
a coolant tube having a first end secured to the coupling manifold, and comprising a first fluid channel and a second fluid channel for the coolant fluid.

7. The system of claim 6, wherein the heat exchanger assembly further comprises:
a first thermally-conductive component secured to a second end of the coolant tube; and
a second thermally-conductive component removably securable to the first thermally-conductive component, the second thermally-conductive component being configured to retain the metal component.

8. The system of claim 1, wherein the motion assembly comprises:
a plate operably supporting at least one of the heat exchanger assembly and the induction coil;
at least one linear bearing assembly operably connected to the plate for restricting movement of the plate to directions along the first axis;
a screw nut secured through the plate;
a threaded screw threadedly engaged with the screw nut for moving the plate based on a rotation of the threaded screw; and
a motor secured to the threaded screw and configured to apply rotational power to the threaded screw.

9. A system for restoring a metal component with a brazing alloy, the system comprising:
a chamber having an interior region;
an induction coil at least partially disposed within the interior region and configured to generate a magnetic field around a portion of a metal component and a portion of a brazing alloy disposed on the metal component;
a thermally-conductive component disposed in the interior region for retaining the metal component, wherein the thermally-conductive component is in conductive contact with the metal component, and wherein the induction coil and the thermally-conductive component are offset along a first axis;
at least one fluid conduit connected to the thermally-conductive component for supplying a coolant fluid to the thermally-conductive component;
a threaded-screw drive mechanism configured to cause relative movement between the metal component and the induction coil along a first axis.

10. The system of claim 9, further comprising a radiation insulator configured to reduce thermal radiation emitted from the metal component.

11. The system of claim 10, wherein the radiation insulator comprises a mold cavity for retaining the brazing alloy.

12. The system of claim 9, wherein the threaded-screw drive mechanism is configured to move the metal component along the first axis relative to the induction coil.

13. The system of claim 9, wherein the threaded-screw drive mechanism is configured to move the induction coil along the first axis relative to the metal component.

14. The system of claim 9, wherein the threaded-screw drive mechanism comprises:
a plate, wherein at least a portion of the at least one fluid conduit is supported by the plate;
at least one linear bearing assembly operably connected to the plate for restricting movement of the plate to directions along the first axis;
a screw nut secured through the plate;
a threaded screw threadedly engaged with the screw nut for moving the plate based on a rotation of the threaded screw; and
a motor secured to the threaded screw and configured to apply rotational power to the threaded screw.

15. A method for restoring a metal component with a brazing alloy, the method comprising:
forming a thermal gradient along the metal component, wherein the thermal gradient extends along a first axis;
causing relative movement between the metal component and an induction coil in a direction along the first axis,
inductively heating successive portions of the brazing alloy with the induction coil while causing the relative movement between the metal component and the induction coil, thereby allowing the melted successive portions of the brazing alloy to directionally solidify to the metal component along the first axis.

16. The method of claim 15, further comprising maintaining a vacuum around the metal component and the brazing alloy while inductively heating the successive portions of the brazing alloy.

17. The method of claim 15, further comprising restricting the emission of thermal radiation from the metal component and the brazing material while inductively heating the successive portions of the brazing alloy.

18. The method of claim 15, wherein forming the thermal gradient along the metal component comprises cooling a first portion of the metal component and heating a second portion of the metal component, wherein the first and second portions of the metal component are offset along the first axis.

19. The method of claim 15, wherein causing the relative movement between the metal component and the induction coil comprises rotating a threaded screw that is engaged with a threaded nut, wherein the threaded nut is secured to a plate that operably supports at least one of the metal component and the induction coil.

20. The method of claim 15, wherein the relative movement is performed at a movement rate that substantially corresponds to a growth rate of the solidified brazing alloy.
